(19) United States
(12) Patent Application Publication
(10) Pub. No.: US 2021/0251294 A1
(43) Pub. Date: Aug. 19, 2021

(54) INDUCTION HEATING SYSTEM AND HEATER

(71) Applicant: NICOVENTURES TRADING LIMITED, London (GB)

(72) Inventor: Walid ABI AOUN, London (GB)

(21) Appl. No.: 17/250,197

(22) PCT Filed: Jun. 11, 2019
(86) PCT No.: PCT/EP2019/065253

§ 371 Date: Dec. 14, 2020

(30) Foreign Application Priority Data
Jun. 14, 2018 (GB) 1809786.5

(51) Int. Cl. A24F 40/465; A24F 40/44; A24F 40/10; B28B 21/04; A24F 40/70; B28B 23/00; H05B 6/10

(52) U.S. Cl. CPC A24F 40/465; A24F 40/44; A24F 40/10; H05B 6/108; A24F 40/70; B28B 23/0081; B28B 21/04

(57) ABSTRACT

An inductive heater for an aerosol generating device is provided. The inductive heater includes a heater element for heating aerosol generating material. The heater element includes a ceramic member and susceptor material integrally formed with the ceramic member. The susceptor material is arranged in use to be heated by electromagnetic induction.

### PRIORITY CLAIM

The present application is a National Phase entry of PCT Application No. PCT/EP/065253, filed Jun. 11, 2019, which claims priority from GB Patent Application No. 1809786.5, filed Jun. 14, 2018, each of which is hereby fully incorporated herein by reference.

### TECHNICAL FIELD

The present disclosure relates to an induction heating system and a heater for an aerosol generation device.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

According to an aspect of the disclosure , there is provided an inductive heater for an aerosol generating device. The inductive heater comprises a heater element for heating aerosol generating material. The heater element comprises a ceramic member and susceptor material integrally formed with the ceramic member. The susceptor material is arranged in use to be heated by electromagnetic induction.

According to another aspect of the disclosure , there is provided an inductive heater for an aerosol generating device. The inductive heater comprises a heater element including an embedded susceptor material configured to heat when penetrated by a varying magnetic field. The heating element is further arranged to wick aerosolizable material in a liquid form. The inductive heater comprises aerosolizable material in a liquid form. The heater element is saturated with the aerosolizable material in a liquid form.

The heater element may have a greater concentration of ceramic member to susceptor material.

The heater element may have a greater concentration of susceptor material to ceramic member.

The concentration ratio of susceptor material to ceramic member in a first region of the heater element may be different to the concentration ratio of susceptor material to ceramic member in a second region of the heater element.

The heater element may be elongate and the concentration ratio of susceptor material to ceramic member varies along the length of the heater element.

The susceptor material may be in the form of at least one of the following: beads, flakes, particles, shards, rods and tubes. The susceptor material may be a metal. The susceptor material may be a ferrous metal.

The susceptor material may comprise at least two types of susceptor material, wherein the concentration ratios of the types of susceptor material to ceramic member vary across the heater element.

The ceramic member may be in the form of a hollow tube for receiving aerosolizable material. The ceramic member may be arranged to provide a wicking function for wicking aerosol generating material to the ceramic member. The ceramic member may be formed of sintered ceramic material.

The heater may be saturated with aerosolizable material in liquid form.

An induction heating system for an aerosol heating device may be provided. The induction heating system may comprise an inductive heater as disclosed herein and an electromagnetic field generator to heat the inductive heater.

According to another aspect of the disclosure, there is provided a method of manufacturing an inductive heater for an induction heating system of an aerosol generating device. The method comprises: providing a ceramic material; dosing the ceramic material with a susceptor material at a pre-determined concentration; and forming the dosed ceramic material into the desired shape of the inductive heater.

The ceramic material may be provided in a slurry form and the dosed ceramic material may be molded into the desired shape of the inductive heater.

The ceramic material may be provided in a powder form and the dosed ceramic material may be formed into the desired shape of the inductive heater and then sintered to fix the shape of the inductive heater.

The dosed ceramic material may be formed into a hollow tube.

Further features and advantages of the disclosure will become apparent from the following description of preferred embodiments of the disclosure, given by way of example only, which is made with reference to the accompanying drawings.

### BRIEF DESCRIPTION OF THE DRAWINGS

FIG. 1 shows a schematic, perspective sectional view of a heater element according to an example.

FIG. 2 shows a schematic, perspective sectional view of a heater element according to an example.

FIG. 3 shows a schematic, perspective sectional view of a heater element according to an example.

FIG. 4 shows a schematic, perspective sectional view of a heater element according to an example.

FIG. 5 shows a schematic, perspective view of a heater element according to an example.

FIG. 6 shows a schematic, cross-sectional view of an aerosol generating device according to an example.

### DETAILED DESCRIPTION

Induction heating is a process of heating an electrically conductive object by electromagnetic induction. The electrically conductive object may be known as a susceptor. An induction heater may comprise an electromagnet and a device for passing a varying electric current, such as an alternating electric current, through the electromagnet. The varying electric current in the electromagnet produces a varying magnetic field. The varying magnetic field penetrates a susceptor suitably positioned with respect to the electromagnet, generating eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as Iron, Nickel or Cobalt, heat may also be generated by magnetic hysteresis losses in the susceptor, i.e. by the varying orientation of magnetic dipoles in the magnetic material as a result of their alignment with the varying magnetic field.

In inductive heating, as compared to heating by conduction for example, heat is generated inside the susceptor, allowing for rapid heating. Further, there need not be any physical contact between the inductive heater and the susceptor, allowing for enhanced freedom in construction and application.

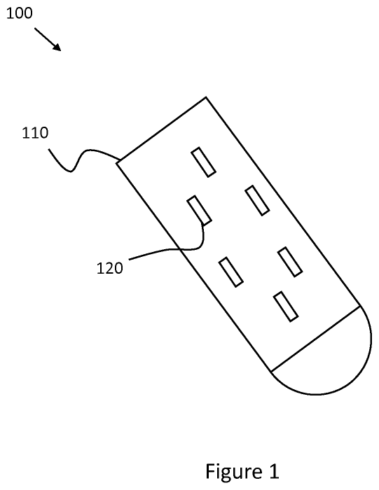

Referring to FIG. 1 there is shown a schematic, perspective sectional view of an example of a heater element 100 having a ceramic member 110 and susceptor material 120 arranged within the ceramic member 110. The heater element 100 is arranged so that the susceptor material 120 will generate thermal energy once the heater element 100 is placed within an operating electromagnetic induction system. In other words, the heater element 100 is for use as an inductive heater. The ceramic member 110 will retain the heat generated by the susceptor material 120 and as such the heater element 100 acts efficiently to provide thermal energy. The ceramic member 110 may be of any shape with the susceptor material 120 embedded within the ceramic member 110.

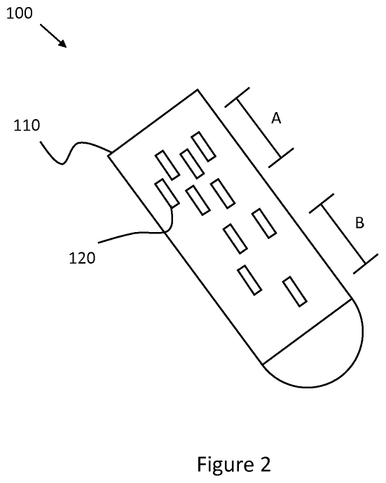

Referring to FIG. 2, there is shown a schematic, perspective sectional view of another example of a heater element 100. The heater element 100 of FIG. 2 has two regions: region A and region B. The susceptor material 120 is unevenly distributed between the two regions, such that region A has a greater amount of susceptor material 120 in comparison to region B. In other words, region A has a smaller amount of ceramic in comparison to region B. The effect of this uneven distribution of susceptor material 120 is that, when the heater element 100 of FIG. 2 is exposed to an electromagnetic field, region A will heater up faster than region B since it has a greater concentration of susceptor material 120 to ceramic material 110 than in region B. Additionally, because there is less ceramic material in region A, the overall level of insulation in region A may be relatively less in comparison to region B and, thus, heat may more readily escape from region A of the heater element 100. In this way, a heater element 100 with a specific heating profile can be created by virtue of the arrangement of susceptor material 120 within the heater element 100. This may be useful in order to heat different regions of any aerosolizable material in contact with/in the vicinity of the heater element 100 differently. This may be influenced by the type(s) of aerosolizable material to be heated, the air flow characteristics over/through the heater element 100 when the heater element 100 is used in an aerosol provision device, and/or the distance from a heated region to a mouthpiece.

In the example shown in FIG. 2, region A is arranged towards one end of the heater 100 and region B is arranged towards the other end of the heater 100. In other words, the amount of susceptor material 120 arranged within the ceramic member 110 susceptor material varies lengthwise along the length of the heater element 100. As would be understood by the skilled reader, other arrangements are conceivable. In other words, the concentration of susceptor material can vary along any direction relative to the heater. For instance, in addition or alternatively, the amount of susceptor material 120 arranged within the ceramic member 110 may be varied across the width of the heater 100. When the amount of susceptor material 120 varies in two-dimensions, e.g., a width and a length, a two-dimensional heating profile may be formed by the heater element 100 in use. In one example, the heater element 100 may have an array of regions, each region of which has a desired amount of susceptor material 120 arranged with the ceramic member 110. Each region may therefore be thought of as a ‘heating spot’ having its own particular rate of heating based upon the amount of susceptor material 120 arranged in that region.

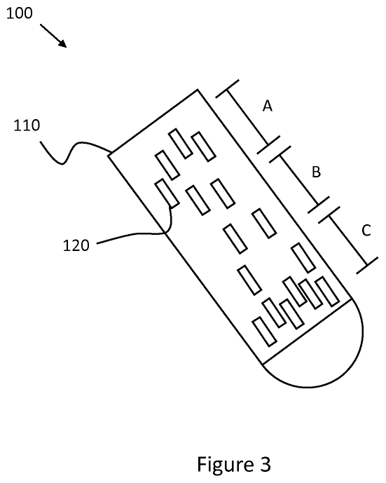

Referring now to FIG. 3, there is shown a schematic, perspective sectional view of another example of a heater element 100. The heater element 100 of FIG. 3 has three regions; region A, region B and region C. The susceptor material 120 is unevenly distributed between the three regions such that region A has a greater amount of susceptor material 120 in comparison to region B, and region C has a greater amount of susceptor material 120 in comparison to region A. As with the example of the heater element 100 of FIG. 2, the uneven distribution of susceptor material 120 causes a specific heating profile for the heater 100 of FIG. 3. The region C will heat up most quickly, followed by region A and then region B. In the example shown, region C is towards one end of the heater element 100, region A is towards the other end of the heater element 100 while region B is located between regions A and C. Again, as with FIG. 2, the amount of susceptor material 120 arranged within the ceramic member 110 susceptor material varies lengthwise along the length of the heater element 100 illustrated in FIG. 3. The specific heating profiles provided by the heater elements 100 shown in FIGS. 2 and 3 can be best used in conjunction with a specialized aerosolizable material which may vary along its length. Optionally, the specialized aerosolizable material may also vary across its width if desired. In this way, the heater can generate aerosol from specific sections or portions of the aerosolizable material that is substantially aligned with regions A and B (and C for FIG. 3) at specific times during a smoking session. In an example, the aerosolizable material may have a tobacco portion, substantially aligned with the quickly heating region A, and a menthol portion, substantially aligned with the slowly heating region B, such that the smoking session starts with a tobacco aerosol and finishes with a menthol aerosol.

The amount of susceptor material 120 arranged within the ceramic member 110 in each region (A, B or C, for example) may be arranged so that the peak temperature of each region, when heated up in use, stabilizes at substantially the same temperature but the time taken to for each of the regions to reach its peak temperature varies according to the desired heating profile of the particular heater element 100. In other words, the heating rate of each region will vary in use.

Alternatively, the amount of susceptor material 120 arranged within the ceramic member 110 in each region (A, B or C, for example) may be arranged so that the peak temperatures of each region, when heated up in use, vary by both value and time taken to reach that peak temperature. The amount of susceptor material 120 arranged within the ceramic member 110 in each region will be arranged according to the desired heating profile of the particular heater element 100. In other words, both the heating rate and the ultimate peak temperature of each region will vary in use. It should also be appreciated that the type of susceptor material may vary in each of the regions (in addition to or alternatively to the concentration), where the type of susceptor material has different heating characteristics (e.g., heat up rate, operating temperature, etc.) and thus a variation in the temperatures of each region may also be influenced by the choice of susceptor material in each region.

In an example, the heater element 100 may be manufactured by mixing a ceramic slurry with the appropriate amount of susceptor material 120. The ceramic slurry may be placed in a mold. The ceramic slurry may then be left to set and to dry. The ceramic slurry may then be fired to make the ceramic hard and rigid and so form the ceramic member 110 of the heater element 100. In an example, the appropriate amount of susceptor material 120 may be mixed through a portion of the ceramic slurry that will eventually form the respective region of the heater element 100. In other words, the ceramic slurry is dosed with the susceptor material 120. The susceptor material 120 may be mixed through the portion of the ceramic slurry evenly or unevenly as determined by the desired heating profile. The portion of the ceramic slurry may then be added to the mold in the respective position. Other portions of ceramic slurry corresponding to other regions having different amounts (or types as discussed below) of susceptor material 120 may then be added to the mold depending on the heating profile desired from the heater element 100.

In another example, the appropriate amount of susceptor material 120 for a region of the heater element 100 may be added to ceramic slurry that is already in a mold. The appropriate amount of susceptor material 120 may be added at the appropriate location in the mold and mixed through in situ before the slurry is set and fired. The susceptor material 120 may be mixed through the portion of the ceramic slurry evenly or unevenly as determined by the desired heating profile. Other amounts of susceptor material 120 may then be added to other locations of the mold containing the ceramic slurry that corresponds to different heating regions depending on the heating profile desired from the heater element 100.

In another example, the ceramic member 110 may be made by sintering ceramic powder to from the ceramic member 110. The ceramic powder may be pressed or molded into the ultimate shape of the ceramic member 110 before the powder is sintered. In an example, the appropriate amount of susceptor material 120 may be added and mixed to a portion of the ceramic powder. That portion of the powder, which corresponds to a respective region of the heater element 100, can then be arranged relative to other portions of ceramic powder corresponding to other regions of the heater element having different amounts of susceptor material 120. The completed arrangement can then be formed and sintered. As discussed below, the sintering process allows a heater element 100 to be formed in which the ceramic member 110 is porous. A porous ceramic member 110 may have wicking properties that allow an aerosolizable liquid to be wicked to a heating position on the heater element 100.

As would be apparent to the skilled reader, the amount of the susceptor material 120 arranged in the ceramic member 110 may be also be described as the concentration of the susceptor material 120 within the ceramic member 110. In order to produce the heater element 100, the amount of susceptor material 120 may be measured in a concentration ratio with the ceramic member 110. The concentration ratio of amount of susceptor material 120 to ceramic member 110 may vary by region of the heater element 100. For example, one of the regions (A, B, or C, for example) may have a different concentration ratio of susceptor material 120 to ceramic member 110 from another one of the regions. As one with knowledge of the art would appreciate, the concentration ratio within the final heater element 100 may be different from the concentration ratios of raw susceptor material to raw ceramic due to the manufacturing process. For example, water loss during the manufacturing process may need to be accounted for.

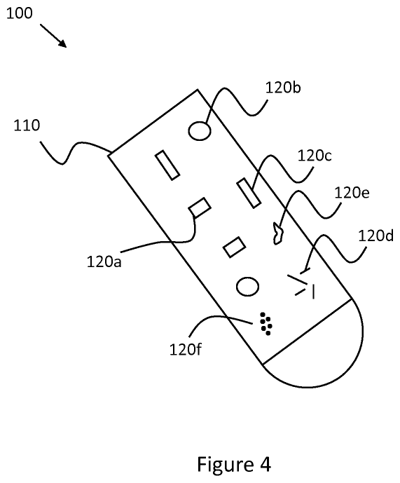

Referring to FIG. 4, there is shown a schematic, perspective sectional view of another example of a heater element 100. The heater element 100 has a ceramic member 110 and susceptor material 120 in various forms. The susceptor material 120 may be in the form of any of rods 120a, beads 120b, tubes 120c, shards 120d, flakes 120e or particles 120f The susceptor material 120 may formed from one type of susceptor material or it may be formed from two or more types of susceptor materials. Different susceptor types allow different peak temperatures to be reached. The variation in both type of susceptor material 120 and the amount of that type of susceptor material 120 in a particular region of the ceramic member 110 allows a very precise heating profile to be created. The heater element 100 shown in FIG. 4 may be formed in the same manner as described above with respect to FIGS. 1-3.

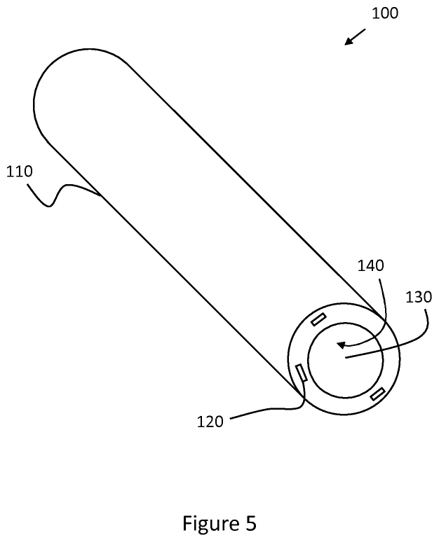

Referring now to FIG. 5, there is shown a schematic, perspective view of a heater element 100. The heater element 100 has a ceramic member 110 and susceptor material 120 as with previous examples, but this heater element 100 has been formed in the shape of a hollow tube and therefore has an opening 130 to a through-hole 140 from one end of the heater element 100 to the other. When the heater element 100 of FIG. 5 is placed into an electromagnetic field, the susceptor material 120 will generate heat which the ceramic member 110 will retain and radiate to the surrounding environment. The through-hole 140 will be heated by the surrounding heater element 100 and heat in the through-hole 140 will be retained efficiently. The heater element 100 will therefore act as an oven, creating a high temperature within the through hole 140 into which can be placed aerosolizable material. As with the examples of FIGS. 2, 3 and 4, the heater element 100 of FIG. 5 may have variations in both the amounts, and types, of susceptor material 120 in heater element 100. For example, the heater element 100 may have a higher amount of susceptor material 120 located in one region of the heater element 100 than in another region of the heater element 100. In an example, the susceptor material 120 may be more concentrated at one end of the heater element 100 so that the oven is hottest at that end so that aerosol generation is effected more quickly. In other words, the amount of susceptor material 120 arranged within the ceramic member 110 susceptor material varies lengthwise along the length of the hollow tube heater element 100.

The heater element 100 shown in FIG. 5 may be formed in the same manner as described above with respect to FIGS. 1-4.

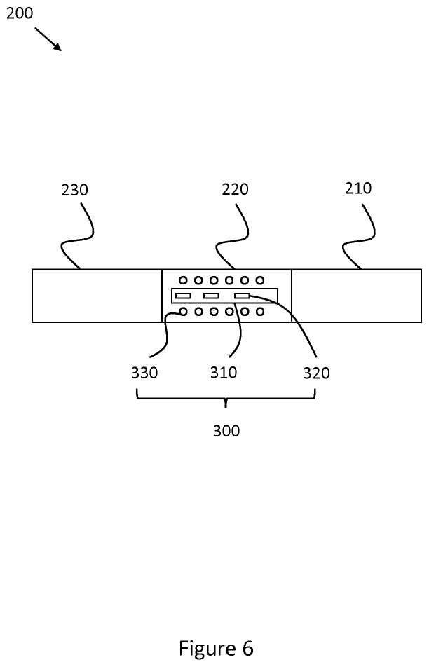

Referring now to FIG. 6, there is shown an aerosol generating device 200 having a power unit 210, a heating unit 220 and a mouthpiece 230. The mouthpiece 230 is located towards the proximal end of the device 200 while, in the example shown the power unit 210 is located towards the distal end of the device 200. The heating unit 220 is located between the power unit 210 and the mouthpiece 230, in the example shown.

The heating unit 220 houses a heater 300. The heater 300 has a ceramic member 310 which has susceptor material 320 embedded in it. The heater 300 also has a coil 330 or a series of coils 330 that carry current. The coils 330 provide the electromagnetic field so as to cause heating of the susceptor material 320 in the ceramic member 310. The coils 330 are connected to a power source provided in the power unit 210 of the device 200.

The ceramic member 310 may be formed in the same manner as the heater elements 100 referred to in FIGS. 1-5. Thus, the ceramic member 310 may be formed from a ceramic slurry which is cast or molded . In another example, the ceramic slurry may be extruded into a tubular shape. The slurry may be dosed with susceptor particulates. The slurry may then be finished into a hollowed shape.

As also discussed above with respect to FIGS. 1-5, the ceramic member 310 may instead be made by sintering, by application of pressure, or any other technique for forming a porous ceramic. For example, the ceramic member 310 may be manufactured through isostatic pressing, plastic forming (jiggering, extruding or injection molding , for example), or by casting. In this way the ceramic member 310 created would be porous and therefore could act as a wick for pulling aerosol generating material from a store of aerosol generating material in the device 200, for example, via capillary force. The ceramic member 310 would therefore act as both the wick and the heater for the device 200. In an example, one end of the ceramic member 310 may project into a store of aerosol generating material so as to pull the aerosol generating material to the heater 300 for aerosolization during a smoking session.

The ceramic member 310 may also be used as a consumable item. In an example, the ceramic member 310 embedded with susceptor material 320 may be saturated with aerosol generating material, such as for example e-liquid or concentrated tobacco extract and aerosol generating agent, such as for example glycerol to form a disposable consumable for use in an aerosol generating device 200. Alternative materials include concentrated tobacco extract and a binding agent, such as for example sodium alginate. The material may also include, additionally or alternatively, a flavor or flavorant . As used herein, the terms “flavor ” and “flavorant ” refer to materials which, where local regulations permit, may be used to create a desired taste or aroma in a product for adult consumers. The susceptor material 320 types and amounts used may be specifically chosen to work favorably with pre-saturated aerosol generating material. For example, if one of the ceramic members 310 has one type of aerosol generating material at one end which is to be aerosolized first in a smoking session and a second type of aerosol at a second end which is to aerosolized second in the smoking session, the susceptor material 320 may be weighted towards the first end, or the type of susceptor material at the first end may be chosen so as to reach a higher temperature than the type at the second end.

A series of heaters 300 may be provided with similar or different loadings of susceptor material 320 with each heater 300 configured to provide a similar or different heating profile in use. In this way, the heater 300 can be removed from an aerosol generating device 200 and replaced with a heater 300 which provides the preferred heating profile for the smoking session. This may be due to a particular selection of aerosolizable material preferentially being heated by a particular heating profile.

The ceramic member 110, 310 may be formed of any suitable ceramic material. For example, the ceramic member 110, 310 may be formed of any suitable ceramic material that can be formed into a rigid cake or a tablet. For example, the ceramic member 110, 310 may be formed of any suitable ceramic material that can be formed into a porous cake or a porous tablet. For example, the ceramic material may be formed of, but not limited to, at least one of the following: alumina, zirconia, yttria, calcium carbonate, and calcium sulphate.

The susceptor material 120, 320 may be formed of any suitable susceptor material, for example at least one of, or any combination of, the following: iron, iron alloys such as stainless steel, mild steel, molybdenum, silicon carbide, aluminum , gold and copper.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An inductive heater for an aerosol generating device, comprising:
a heater element for heating aerosol generating material, wherein the heater element comprises a ceramic member and susceptor material integrally formed with the ceramic member, the susceptor material arranged in use to be heated by electromagnetic induction.

2. The inductive heater according to claim 1, wherein the heater element has a greater concentration of the ceramic member relative to the susceptor material.

3. The inductive heater according to claim 1, wherein the heater element has a greater concentration of the susceptor material relative to the ceramic member.

4. The inductive heater according to claim 1, wherein a concentration ratio of the susceptor material to the ceramic member in a first region of the heater element is different than a concentration ratio of the susceptor material to the ceramic member in a second region of the heater element.

5. The inductive heater according to claim 4, wherein the heater element is elongate and the concentration ratio of the susceptor material to the ceramic member varies along a length of the heater element.

6. The inductive heater according to claim 1, wherein the susceptor material is in the form of at least one of the following: beads, flakes, particles, shards, rods, or tubes.

7. The inductive heater according to claim 1, wherein the susceptor material is a metal.

8. The inductive heater according to claim 1, wherein the susceptor material is a ferrous metal.

9. The inductive heater according to claim 1, wherein the susceptor material comprises at least two types of susceptor material, wherein concentration ratios of the types of the susceptor material to the ceramic member vary across the heater element.

10. The inductive heater according to claim 1, wherein the ceramic member is in the form of a hollow tube for receiving aerosolizable material.

11. The inductive heater according to claim 1, wherein the ceramic member is arranged to provide a wicking function for wicking aerosol generating material to the ceramic member.

12. The inductive heater according to claim 11, wherein the ceramic member is formed of sintered ceramic material.

13. The inductive heater according to claim 1, wherein the inductive heater is saturated with aerosolizable material in liquid form.

14. An induction heating system for an aerosol heating device comprising the inductive heater of claim 1 and an electromagnetic field generator to heat the inductive heater.

15. An inductive heater for an aerosol generating device, comprising:
a heater element including an embedded susceptor material configured to heat when penetrated by a varying magnetic field, the heater element further arranged to wick aerosolizable material in a liquid form; and
aerosolizable material in a liquid form, wherein the heater element is saturated with the aerosolizable material in the liquid form.

16. A method of manufacturing an inductive heater for an induction heating system of an aerosol generating device comprising:
providing a ceramic material;
dosing the ceramic material with a susceptor material at a pre-determined concentration; and
forming the dosed ceramic material into a desired shape of the inductive heater.

17. The method of manufacturing an inductive heater according to claim 16, wherein the ceramic material is provided in a slurry form and the dosed ceramic material is molded into the desired shape of the inductive heater.

18. The method of manufacturing an inductive heater according to claim 16, wherein the ceramic material is provided in a powder form and the dosed ceramic material is formed into the desired shape of the inductive heater and then sintered to fix the desired shape of the inductive heater.

19. The method of manufacturing an inductive heater according to claim 16, wherein the dosed ceramic material is formed into a hollow tube.
